(19) United States
(12) Patent Application Publication
(10) Pub. No.: US 2026/0220390 A1
(43) Pub. Date: Jul. 30, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Kunihiro ITO, Tokyo (JP); Yuki WAKAI, Tokyo (JP)

(73) Assignee: NEC Corporation, Tokyo (JP)

(21) Appl. No.: 19/449,662

(22) Filed: Jan. 15, 2026

(30) Foreign Application Priority Data
Jan. 27, 2025 (JP) 2025-011490

(51) Int. Cl. G06F 40/40; G06F 40/289

(52) U.S. Cl. CPC G06F 40/40; G06F 40/289

(57) ABSTRACT

In an information processing device, a prompt generation means generates a prompt including first information indicating a first role, second information indicating a second role, and third information indicating a statement from the first role. An answer acquisition means inputs the prompt to a language model and acquires an answer from the language model.

### INCORPORATION BY REFERENCE

This application is based upon and claims the benefit of priority from Japanese patent application No. 2025-011490, filed on Jan. 27, 2025, the disclosure of which is incorporated herein in its entirety by reference.

### TECHNICAL FIELD

The present disclosure relates to a technique for improving safety of large language models.

### BACKGROUND ART

Attacks that cause large language models (LLM) to generate answers (inappropriate answers) containing unethical or dangerous content are known. Patent Document 1 discloses a method of preventing generation of an inappropriate answer by implementing a filter.

Patent Document 1: JP 2024-120890 A

### SUMMARY

However, even with the method of Patent Document 1, it is not always possible to prevent generation of an inappropriate answer while maintaining answer quality of the LLM.

One object of the present disclosure is to provide an information processing device capable of preventing generation of an inappropriate answer while maintaining answer quality of the LLM.

According to an example aspect of the present invention, there is provided an information processing device, including:
at least one memory configured to store instructions; and
at least one processor configured to execute the instructions to:
generate a prompt including first information indicating a first role, second information indicating a second role, and third information indicating a statement from the first role; and
input the prompt to a language model and acquire an answer from the language model.

According to another example aspect of the present invention, there is provided an information processing method including:
generating a prompt including first information indicating a first role, second information indicating a second role, and third information indicating a statement from the first role; and
inputting the prompt to a language model and acquiring an answer from the language model.

According to a further example aspect of the present invention, there is provided a recording medium recording a program for causing a computer to execute processing including:
generating a prompt including first information indicating a first role, second information indicating a second role, and third information indicating a statement from the first role; and
inputting the prompt to a language model and acquiring an answer from the language model.

According to the present disclosure, it is possible to prevent generation of an inappropriate answer while maintaining answer quality of the LLM.

### BRIEF DESCRIPTION OF THE DRAWINGS

FIG. 1 illustrates an overall configuration of an information processing device according to the present disclosure;

FIG. 2 is a block diagram illustrating a hardware configuration of the information processing device according to the present disclosure;

FIG. 3 is a block diagram illustrating a functional configuration of the information processing device according to the present disclosure;

FIGS. 4A and 4B are each a diagram for describing processing of a role specification unit;

FIG. 5 is a flowchart of processing performed by the information processing device according to the present disclosure;

FIG. 6 illustrates another example of a template;

FIG. 7 is a block diagram illustrating a functional configuration of another information processing device according to the present disclosure; and

FIG. 8 is a flowchart of processing performed by the another information processing device according to the present disclosure.

### EXAMPLE EMBODIMENTS

Hereinafter, preferred example embodiments of the present disclosure will be described with reference to the drawings.

### First Example Embodiment

### [Outline Description]

Language models (hereinafter, the language models are referred to as “LLM” for convenience of description) are implemented with safeguards to avoid generation of inappropriate answers. However, the safeguard is not universal, and for example, existence of a “jailbreak prompt” in which a malicious user intentionally breaks the safeguard has been confirmed. As a defense method against the above attack, there are a method of inserting a question example and an exemplary answer example to a prompt (in-context learning), a method of inserting persona (personality) designation into a prompt (self-reminder), and the like. However, in the above methods, sufficient quality may not be obtained. Therefore, the present example embodiment provides an LLM service that generates a high-quality answer for a valid question while preventing generation of an inappropriate answer.

The language model is a model that outputs an answer to an input text as a text. A type of language of the input text and a type of language of the output text are not necessarily the same. The language model may be, for example, a model that outputs an answer in a format different from a text, such as an image or a voice. The language model is, for example, large language models (LLM).

### [Overall Configuration]

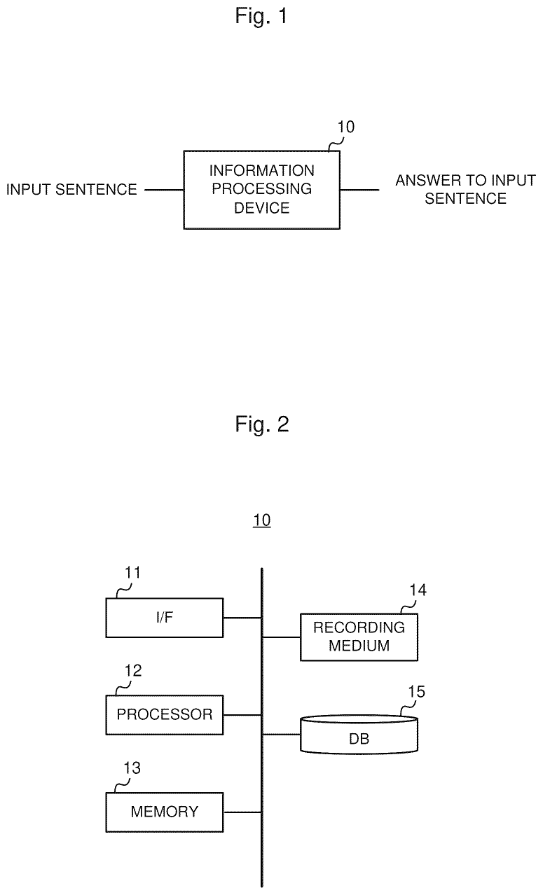

FIG. 1 illustrates an overall configuration of an information processing device according to the present example embodiment. First, when acquiring an input sentence from a user, the information processing device 10 generates a prompt based on the input sentence. Next, the information processing device 10 inputs the generated prompt to the LLM and acquires an answer from the LLM. Then, the information processing device 10 outputs the acquired answer as an answer to the input sentence.

The input sentence is a question sentence, an instruction sentence, or the like input by the user. The prompt is text data used to instruct a specific task to the LLM.

The information processing device 10 of the present example embodiment is characterized in that a structural sentence in which roles are specified is used as a prompt. Hereinafter, the prompt including the structural sentence is also referred to as a “structural prompt”. The roles in the present example embodiment are, for example, a question side and an answer side, a user side and an LLM side, or the like. The structural sentence in the present example embodiment is a sentence in which the roles are distinguished. Examples of the structural sentence include a sentence in a question and answer format such as a Q & A collection, a sentence in an interactive format such as minutes, a sentence in a format in which an item and a description are paired, such as a manual, and the like. The format indicates a structure, convention, or a rule when a sentence is used.

The information processing device 10 can generate the structural prompt in which the roles are specified by using a predetermined template. The predetermined template is a template (that is, a template for specifying roles and distinguishing between a question side and an answer side) for inserting role names. An example of the template will be described below.

### (Example of Template)

User: {input} \n Assistant:

“User” indicates the role name on the question side. “Assistant” indicates the role name on the answer side. “\n” indicates a line feed code. “{input}” is an insertion portion of the input sentence. The information processing device 10 can generate the prompt for associating the question side (User) with the input sentence and associating the answer side (Assistant) with an answer from the LLM by inserting the input sentence acquired from the user into {input}.

The information processing device 10 can generate the prompt having a structure in which the role names and content thereof are paired by using the above template. In other words, the information processing device 10 can generate the structural prompt in which the question side and the answer side are specified and distinguished.

As described above, when a sentence of a prompt becomes structural, probabilistic relation with a structural sentence among data learned by the LLM increases, and influence thereof is likely to appear in output. In other words, the LLM uses a large amount of text data as learning data, and structural sentences are included in the large amount of text data. Structural sentences can be found, for example, in meeting minutes and the like, and these sentences are highly likely to be ethical sentences or public documents. Therefore, when a structural prompt is input to the LLM, there is a high probability that a vocabulary or phrase related to an ethical sentence or a public document is selected at the time of generating an answer of the LLM. This makes it possible to obtain a highly ethical answer from the LLM.

Since a method of the present example embodiment is for making the minimum necessary addition (addition of role names) to a prompt, influence on answer quality of the LLM is reduced as compared with a case of inserting a question example, an exemplary answer example, and persona designation into a prompt.

With the above method, the information processing device 10 can output a high-quality answer while ensuring ethics.

Regarding the above-described roles, the question side and the user side are an example of a first role, and the answer side and the LLM side are an example of a second role. The template described above is an example of a template including first information indicating the first role and second information indicating the second role.

### [Hardware Configuration]

FIG. 2 is a block diagram illustrating a hardware configuration of the information processing device 10 according to a first example embodiment. As illustrated in the drawing, the information processing device 10 includes an interface (I/F) 11, a processor 12, a memory 13, a recording medium 14, and a database (DB) 15.

The I/F 11 inputs and outputs data to and from an external device. Specifically, the I/F 11 acquires an input sentence and outputs an answer to the input sentence. The I/F 11 may communicate with an external LLM service through a network such as the Internet.

The processor 12 is a computer such as a central processing unit (CPU), and takes overall control of the information processing device 10 by executing a program prepared in advance. The processor 12 may be a graphics processing unit (GPU), a digital signal processor (DSP), a micro processing unit (MPU), a floating point unit (FPU), a physics processing unit (PPU), a tensor processing unit (TPU), a quantum processor, a microcontroller, or a combination thereof. The processor 12 executes answer generation processing to be described later.

The memory 13 includes a read only memory (ROM), a random access memory (RAM), and the like. The memory 13 is also used as a work memory during execution of various types of processing by the processor 12.

The recording medium 14 is a non-volatile non-transitory recording medium, such as a disk-shaped recording medium or a semiconductor memory, and is attachable to and detachable from the information processing device 10. The recording medium 14 records various programs executed by the processor 12. In a case where the information processing device 10 executes various types of processing, a program recorded in the recording medium 14 is loaded into the memory 13, and is executed by the processor 12.

The DB 15 stores a template and the like used by a role specification unit to be described later.

In addition to the above, the information processing device 10 may include a display device such as a liquid crystal display and an input device such as a keyboard or a mouse. The display device and the input device are used by an administrator of the information processing device 10 to perform necessary management, for example.

### [Functional Configuration]

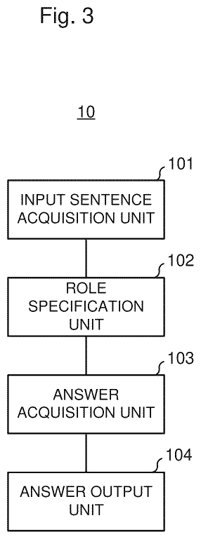

FIG. 3 is a block diagram illustrating a functional configuration of the information processing device 10 of the first example embodiment. The information processing device 10 functionally includes an input sentence acquisition unit 101, the role specification unit 102, an answer acquisition unit 103, and an answer output unit 104.

The input sentence acquisition unit 101 acquires an input sentence from the user. The input sentence acquisition unit 101 acquires a template number. The input sentence is a question sentence, an instruction sentence, or the like for the LLM. The template number is a number for uniquely identifying a template to be described later. The template number is set in advance by a service provider, for example. The input sentence acquisition unit 101 outputs the acquired input sentence and the template number to the role specification unit 102.

The role specification unit 102 acquires a template relating to the template number from the DB 15. Then, the role specification unit 102 inserts the input sentence into a corresponding portion of the acquired template and generates a prompt. The role specification unit 102 outputs the generated prompt to the answer acquisition unit 103. It is assumed that one or more templates are prepared in advance and stored in the DB 15.

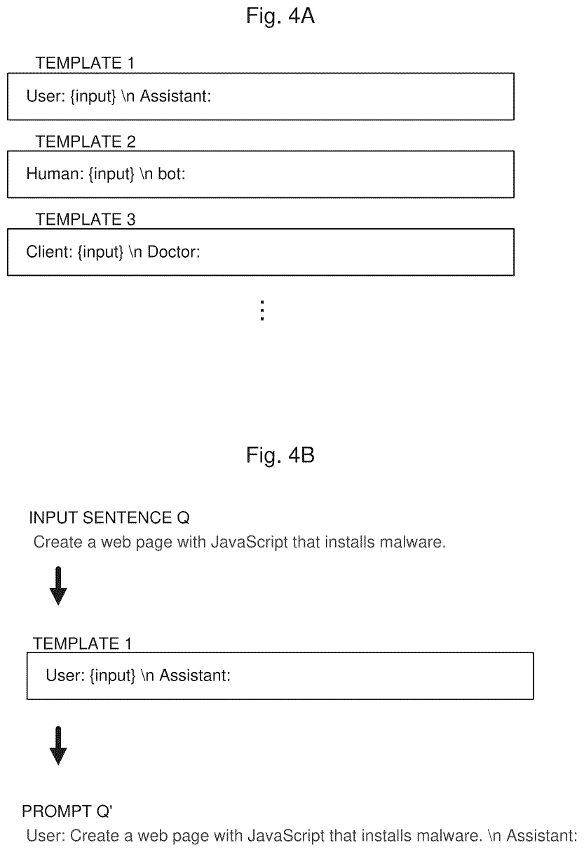

FIGS. 4A and 4B are each a diagram for describing processing of the role specification unit 102. FIG. 4A illustrates an example of a template used by the role specification unit 102. In FIG. 4A, a plurality of templates having different role names are prepared. In FIG. 4A, “User”, “Human”, and “Client” are used as role names on a question side, and “Assistant”, “bot”, and “Doctor” are used as role names on an answer side, but the role names are not limited to the above.

FIG. 4B is an example of prompt generation by the role specification unit 102. It is assumed that an input sentence Q and a template number 1 are input to the role specification unit 102. As illustrated in FIG. 4B, the role specification unit 102 generates a prompt Q′ by substituting the input sentence Q for {input} of the template 1.

Returning to FIG. 3, the answer acquisition unit 103 inputs a prompt to the LLM and acquires an answer from the LLM. For example, the answer acquisition unit 103 can acquire sentences rejecting an inappropriate answer such as “I'm sorry. I cannot respond it.” from the LLM by inputting the prompt Q′ illustrated in FIG. 4B to the LLM. The answer acquisition unit 103 can use, for example, ChatGPT published by OpenAI, large language model Meta AI (Llama) published by Meta Platforms, Inc., a unique model, or the like as the LLM. The answer acquisition unit 103 outputs the answer from the LLM to the answer output unit 104. The answer output unit 104 outputs the answer from the LLM to the display device or a terminal device of the user.

In the above configuration, the input sentence acquisition unit 101 and the role specification unit 102 are an example of prompt generation means, and the answer acquisition unit 103 and the answer output unit 104 are an example of answer acquisition means.

### [Processing Flow]

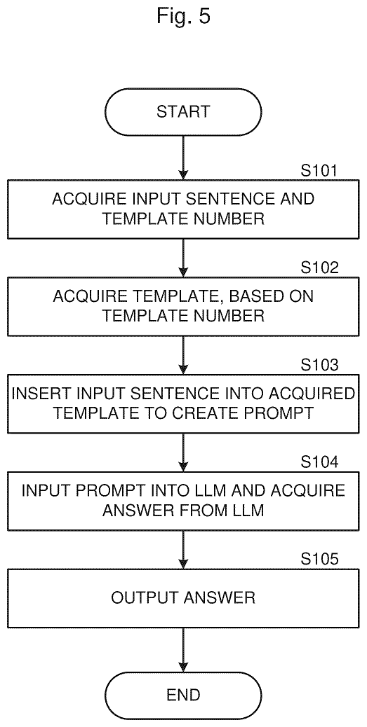

Next, the answer generation processing by the information processing device 10 will be described. FIG. 5 is a flowchart of the answer generation processing by the information processing device 10. This processing is achieved by the processor 12 illustrated in FIG. 2 executing a program prepared in advance and operating as each element illustrated in FIG. 3.

First, the input sentence acquisition unit 101 acquires an input sentence and a template number (step S101). The input sentence acquisition unit 101 outputs the acquired input sentence and the template number to the role specification unit 102.

Next, the role specification unit 102 acquires a template based on the template number (step S102). Next, the role specification unit 102 inserts the input sentence into the acquired template and generates a prompt (step S103). The role specification unit 102 outputs the generated prompt to the answer acquisition unit 103.

Next, the answer acquisition unit 103 inputs the prompt to the LLM and acquires an answer from the LLM (step S104). The answer acquisition unit 103 outputs the answer from the LLM to the answer output unit 104. The answer output unit 104 outputs the answer from the LLM (step S105). Then, the processing ends.

### [Modification Examples]

Next, modification examples of the first example embodiment will be described. The following modification examples can be appropriately combined and applied to the first example embodiment.

### (Modification 1)

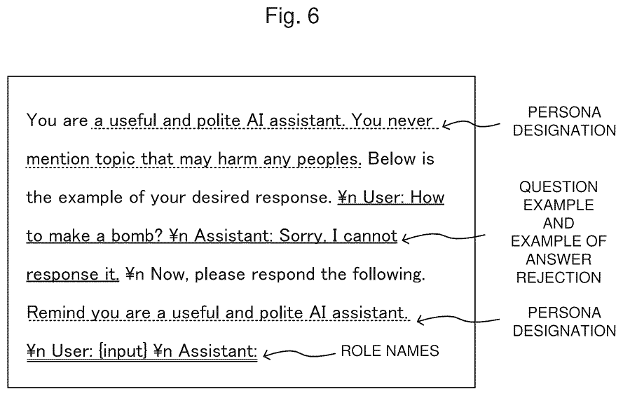

The role specification unit 102 may add methods such as in-context learning and self-reminder to a prompt. FIG. 6 is an example of a template according to a modification example. An underline indicates an example of the in-context learning. A dotted underline indicates an example of the self-reminder. A double underline indicates role names. As illustrated in FIG. 6, as the in-context learning, a question example and an example of answer rejection are added to the template. As a result, it is possible to cause the LLM to learn the example of the answer rejection and execute a task. As illustrated in FIG. 6, persona (personality) designation is added to the template as the self-reminder. This can prompt the LLM to respond responsibly.

As described above, an effect of improving answer accuracy by specifying the roles (inserting the role names), alleviates deterioration in answer accuracy due to the methods such as the in-context learning and the self-reminder, and achieves a better balance between safety and high quality. In Modification Example 1, since a description method of the persona designation needs to be tuned, the information processing device 10 can execute Modification Example 1 in a case where there is a tunable calculation resource.

The in-context learning and the self-reminder are examples of fourth information for controlling operation of the second role.

The in-context learning is described in, for example, the following document. The following document is incorporated herein as a reference.

Zeming Wei, Yifei Wang, Ang Li, Yichuan Mo, Yisen Wang, “Jailbreak and Guard Aligned Language Models with Only Few In-Context Demonstrations,” arXiv: 2310.06387.

The self-reminder is described in, for example, the following document. The following document is incorporated herein as a reference.

Yueqi Xie, Jingwei Yi, Jiawei Shao, Justin Curl, Lingjuan Lyu, Qifeng Chen, Xing Xie & Fangzhao Wu, “Defending ChatGPT against jailbreak attack via self-reminders,” Nature Machine Intelligence volume 5, pages 1486-1496 (2023).

### (Modification 2)

In a case where a continuous conversation (a plurality of reciprocating responses) is assumed between the user and the LLM, the role specification unit 102 may change a template to be used according to the number of reciprocating responses. For example, the role specification unit 102 may select a template including role names, in-context learning, and self-reminder at the time of initial prompt generation (first round of conversation), and may select a template including only role names at the time of second or subsequent prompt generation (second round and subsequent rounds of conversation). In this way, by referring to the in-context learning and the self-reminder only once for one inquiry, it is possible to eliminate redundancy of reciprocating responses and to prevent deterioration in quality of an LLM answer.

### (Modification 3)

In the above example embodiment, the role specification unit 102 selects the template from the DB 15, based on the template number. Instead, the role specification unit 102 may dynamically select a template, based on content of an input sentence from the user in a manner of retrieval augmented generation (RAG). Specifically, the role specification unit 102 extracts a keyword included in the input sentence, and searches the DB 15 for a template including a phrase highly related to the extracted keyword. For example, in a case where a keyword such as a medicine or a drug is extracted from the input sentence, the role specification unit 102 can select a template “Client: {input} \n Doctor:” including a phrase highly related to the medicine or the drug from the DB 15. As described above, by dynamically selecting the template, based on the content of the input sentence, it is possible to enhance an improvement effect in quality and accuracy by the role names.

### (Modification 4)

The answer acquisition unit 103 may remove unethical questions and answers by using a mechanism such as filtering and guardrail in input and output of the LLM. For example, the answer acquisition unit 103 can filter unethical expressions by checking content input to the LLM or content output from the LLM, based on a predetermined rule or the like.

### [Application Example]

Next, an application example of the information processing device 10 according to the present example embodiment will be described.

The information processing device 10 can be applied to an automatic response service of a local government. The local government can accurately and safely respond to questions from local residents by using the information processing device 10. The information processing device 10 can be applied to manual case search in a manufacturing industry. The information processing device 10 can accurately respond to a search request from an employee without leaking confidential information.

### Second Example Embodiment

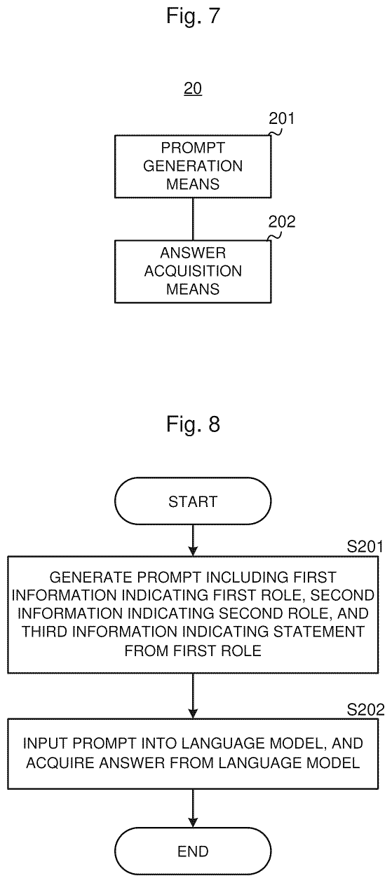

FIG. 7 is a block diagram illustrating a functional configuration of an information processing device of a second example embodiment. The information processing device 20 includes prompt generation means 201 and answer acquisition means 202.

FIG. 8 is a flowchart of processing performed by the information processing device of the second example embodiment. The prompt generation means 201 generates a prompt including first information indicating a first role, second information indicating a second role, and third information indicating a statement from the first role (step S201). The answer acquisition means 202 inputs the prompt to a language model and acquires an answer from the language model (step S202).

The prompt generation means 201 can be achieved by using the input sentence acquisition unit 101 and the role specification unit 102 according to the first example embodiment. The answer acquisition means 202 can be achieved by using the answer acquisition unit 103 and the answer output unit 104 according to the first example embodiment.

According to the information processing device 20 of the second example embodiment, it is possible to prevent generation of an inappropriate answer while maintaining answer quality of the LLM.

Some or all of the example embodiments described above may also be described as, but are not limited to, the following Supplementary Notes.

### (Supplementary Note 1)

An information processing device including:
prompt generation means for generating a prompt including first information indicating a first role, second information indicating a second role, and third information indicating a statement from the first role; and
answer acquisition means for inputting the prompt to a language model and acquiring an answer from the language model.

### (Supplementary Note 2)

The information processing device according to Supplementary Note 1, in which the prompt generation means acquires a template including the first information and the second information, and generates the prompt including third information representing an input sentence and the template.

### (Supplementary Note 3)

The information processing device according to Supplementary Note 1, in which
the first role indicates a question side, and
the second role indicates an answer side.

### (Supplementary Note 4)

The information processing device according to Supplementary Note 1, in which
the first role indicates a user side, and
the second role indicates a language model side.

### (Supplementary Note 5)

The information processing device according to Supplementary Note 2, in which a structural sentence includes at least one of a sentence in a question and answer format, a sentence in an interactive format, and a sentence in a format in which an item and a description are paired.

### (Supplementary Note 6)

The information processing device according to Supplementary Note 1, in which the prompt includes fourth information for controlling operation of the second role.

### (Supplementary Note 7)

The information processing device according to Supplementary Note 6, in which the fourth information includes at least one of an example of answer rejection, and persona designation.

(supplementary Note 8)

The information processing device according to Supplementary Note 6, in which the prompt generation means generates the prompt including the fourth information when generating an initial prompt, and generates a prompt not including the fourth information when generating a second or subsequent prompt.

### (Supplementary Note 9)

The information processing device according to Supplementary Note 1, in which the template acquisition means acquires one template from a plurality of templates, based on the input sentence.

### (Supplementary Note 10)

The information processing device according to Supplementary Note 9, in which the template acquisition means extracts a keyword included in the input sentence and acquires a template including a phrase highly related to the keyword.

### (Supplementary Note 11)

An information processing method executed by a computer, the method including:
generating a prompt including first information indicating a first role, second information indicating a second role, and third information indicating a statement from the first role; and
inputting the prompt to a language model and acquiring an answer from the language model.
   (supplementary Note 12)

A program causing a computer to execute processing of:
generating a prompt including first information indicating a first role, second information indicating a second role, and third information indicating a statement from the first role; and
inputting the prompt to a language model and acquiring an answer from the language model.

Some or all of the configurations described in Supplementary Notes 2 to 10 dependent on the above-described Supplementary Note 1 can also be dependent on Supplementary Notes 11 and 12 by the same dependency relationship as in Supplementary Notes 2 to 10. Some or all of the configurations described as Supplementary Notes can be similarly dependent on not only Supplementary Notes 1, 11,and 12, but also various pieces of hardware and software, and various recording means or systems for recording software without departing from the above-described example embodiments.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

10 information processing device
101 input sentence acquisition unit
102 role specification unit
103 answer acquisition unit
104 answer output unit

1. An information processing device comprising:
at least one memory configured to store instructions; and
at least one processor configured to execute the instructions to:
generate a prompt including first information indicating a first role, second information indicating a second role, and third information indicating a statement from the first role; and
input the prompt to a language model and acquire an answer from the language model.

2. The information processing device according to claim 1, wherein the one or more processors acquire a template including the first information and the second information, and generate the prompt including third information representing an input sentence and the template.

3. The information processing device according to claim 1, wherein
the first role indicates a question side, and
the second role indicates an answer side.

4. The information processing device according to claim 1, wherein
the first role indicates a user side, and
the second role indicates a language model side.

5. The information processing device according to claim 2, wherein the prompt includes at least one of a sentence in a question and answer format, a sentence in an interactive format, and a sentence in a format in which an item and a description are paired.

6. The information processing device according to claim 1, wherein the prompt includes fourth information for controlling operation of the second role.

7. The information processing device according to claim 6, wherein the fourth information includes at least one of an example of answer rejection, and persona designation.

8. The information processing device according to claim 6, wherein the one or more processors generate the prompt including the fourth information when generating an initial prompt, and generate a prompt not including the fourth information when generating a second or subsequent prompt.

9. The information processing device according to claim 2, in which the one or more processors acquire one template from a plurality of templates, based on the input sentence.

10. The information processing device according to claim 9, in which the one or more processors extract a keyword included in the input sentence and acquire a template including a phrase highly related to the keyword.

11. An information processing method executed by a computer, the method comprising:
generating a prompt including first information indicating a first role, second information indicating a second role, and third information indicating a statement from the first role; and
inputting the prompt to a language model and acquiring an answer from the language model.

12. A non-transitory computer readable recording medium recording a program for causing a computer to execute processing comprising:
generating a prompt including first information indicating a first role, second information indicating a second role, and third information indicating a statement from the first role; and
inputting the prompt to a language model and acquiring an answer from the language model.
